(19) United States
(12) Patent Application Publication
(10) Pub. No.: US 2005/0063344 A1
(43) Pub. Date: Mar. 24, 2005

(54) Methods and apparatus for efficient decoding

(75) Inventor: Ola Winzell, Sodra Sandby (SE)

Correspondence Address: BURNS DOANE SWECKER & MATHIS L L P, POST OFFICE BOX 1404, ALEXANDRIA, VA, 22313-1404, US

(73) Assignee: Telefonaktiebolaget LM Ericsson (publ), Stockholm (SE)

(21) Appl. No.: 10/666,267

(22) Filed: Sep. 22, 2003

(51) Int. Cl. H04B 7/216

(52) U.S. Cl. 370/335; 370/342

(57) ABSTRACT

A determination of whether to decode a received packet is performed based upon a determination of the likelihood of decoding the received packet. The likelihood of successful decoding of the received packet is based upon a channel quality indication determined during a period of time and a transport format employed for the packet received during the period of time.

### BACKGROUND

As the popularity of communication in radio communications networks continues to grow, there has been increased interest in providing packet data communications in radio communications networks. High-Speed Downlink Packet Access (HSDPA) is a service which is currently being developed for providing packet data communications in radio communications networks.

Due to the differences between voice communications and packet data communications, the design of these systems can be quite different. For example, since voice communications in radio communications networks are treated as a single stream of information, a single channel is typically reserved for each voice communication. In contrast, packet data communications can be discontinuous, and hence, many packet data communications can share access to a single channel.

Accordingly, the HSDPA service provides for adaptive coding and modulation in the downlink, i.e., the communication channel from the radio communications network to a radio receiver. Specifically, the transport format, (i.e., the channel coding and modulation), that is to be used for transmission by the radio communications network is determined for each transmitted packet. The choice of transport format selected by the radio communications network is based upon a Channel Quality Indicator (CQI) value reported by the radio receiver which is to receive the transmitted packet. The transport format may also be based on the received power control commands or on other information that can be estimated by the base station, e.g., power and quality of the data symbols on the uplink.

The CQI value reported by the radio receiver corresponds to a preferred coding and modulation format such that if the next packet is transmitted under the same radio conditions as during the measurement period and the packet is transmitted with the coding rate and modulation corresponding to the reported CQI, the received data packets would have a packet error rate of approximately 10%. The CQI values and the corresponding transport formats are defined such that an increase in the CQI value by one corresponds to improved receiving conditions by 1 dB. For each user equipment class the CQI can vary between values of 0 to 30, wherein 0 corresponds to out-of-range, 1 corresponds to the poorest receiving conditions and the lowest data rate, and 30 corresponds to the best conditions and the highest data rate.

Since HSDPA operates in a radio environment, a CQI value reported by a radio receiver during a first period of time (T1) may not accurately reflect the channel conditions when a packet is transmitted using a transport format based upon the reported CQI during a subsequent period of time (T2). For example, the CQI value may be measured during a period of time when there are good channel conditions, e.g., channel conditions corresponding to a CQI value of 25. Accordingly, this CQI will be reported to the radio communications network, which will select a transport format based upon the received CQI. Since the CQI is measured during a period of time (T1) when there are good channel conditions, the radio network will likely select a transport format with a minimum protection of the data from errors. The packet is then transmitted during a second period of time (T2). If during this second period of time (T2) the channel quality is much lower than the channel quality measured during the first period of time (T1), then the transport format selected by the radio network may not be adequate to protect the data in the packet transmitted during the second period of time (T2). Accordingly, the receiver will likely not be able to decode the packet transmitted during the second period of time (T2), and hence, will require a retransmission of the packet.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, a determination is made prior to decoding whether to decode a particular packet. Specifically, a channel quality indication is determined during a period of time. During that period of time a packet is received, the received packet being transmitted using a transport format. Based on the determined channel quality indication and the transport format, it is determined whether to decode the received packet. If it is determined that the received packet should not be decoded, then a negative acknowledgment is sent from the receiver to the transmitter requesting retransmission of the packet during another period of time.

### BRIEF DESCRIPTION OF THE DRAWINGS

The objects and advantages of the invention will be understood by reading the following detailed description in conjunction with the drawings in which:

FIG. 1A is a block diagram of a conventional receiver.

FIG. 1B is a block diagram of a receiver in accordance with one embodiment of the present invention.

FIG. 2 is a flow diagram of the determination whether to decode a received packet in accordance with the present invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

For ease of explanation the user equipment, e.g., a wireless radio transceiver, is referred to generally as a receiver. However, the user equipment can contain a transmitter for communication with the radio communications network. Additionally, for ease of explanation the radio communications network entity which communicates with the user equipment, e.g., a base station, is referred to generally as a transmitter. However, the radio communications network entity which communicates with the user equipment can also have a receiver for communication with the user equipment.

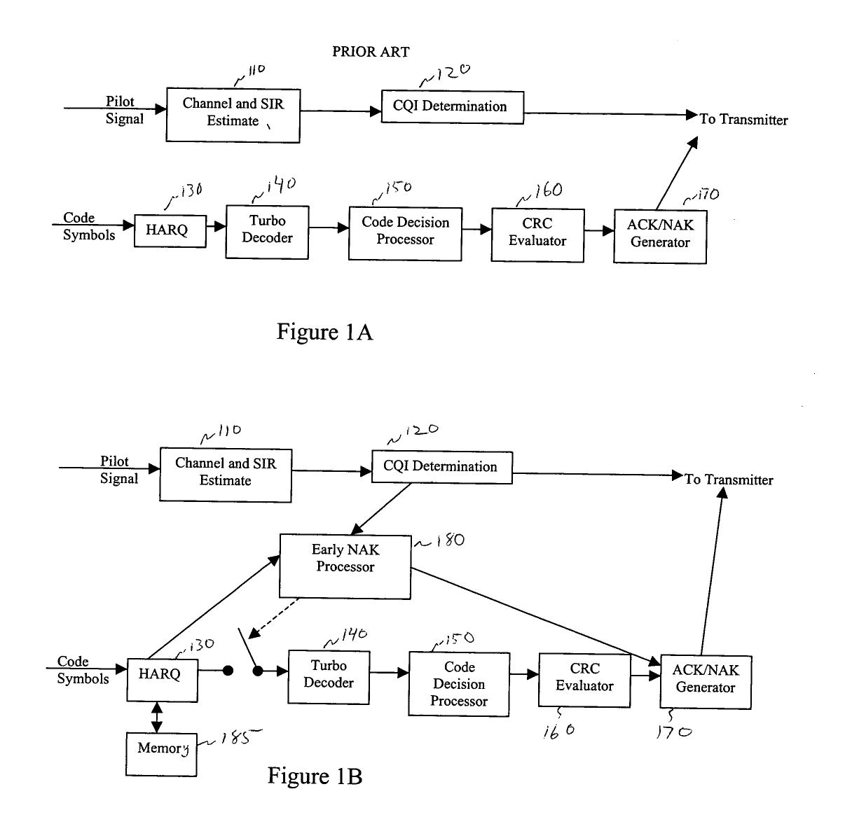

FIG. 1A is a block diagram of a conventional receiver. As illustrated in FIG. 1A the receiver receives and processes a pilot signal and code symbols. The pilot signal is received on a first channel, for example, a control channel. The code symbols are transmitted in user-data packets, which are also known in the art as transport blocks. Processing block 110 uses the pilot signal to perform a channel and SIR estimation. The channel and SIR estimates are provided to CQI determination block 120 for use in the CQI determination.

Systems which employ the HSDPA service provide for a Hybrid Automatic Retransmission Request (HARQ) scheme. If a packet is not able to be decoded by the receiver, the packet will be retransmitted, possibly with additional redundancy. The retransmitted packet is soft-combined in the receiver, e.g., in the HARQ processing block 130, with the previously failed version of the packet which has been stored by the receiver. Accordingly, the code symbols are received on a second channel, i.e., the High Speed Downlink Shared Channel (HS-DSCH), and are processed by HARQ processing block 130. The HARQ processing block provides the received packet to a decoder 140, for example a Turbo decoder.

Turbo decoders in receivers operate in response to a Turbo encoder at the transmitter to produce error resistant communications. Turbo decoders typically operate by performing a number of decoding iterations on a received packet to produce soft values. The number of decoding iterations of a Turbo decoder is typically based upon how much influence the channel has on the received packet. The more influence that the channel has on the received packet, the more iterations of the Turbo decoder will be required to produce the soft values. Accordingly, processing packets which have been greatly influenced by the channel can consume a large amount of processing resources in the receiver.

Soft values arrived at by the Turbo decoder are provided to code decision processor 150 which uses the soft values to recover the transmitted code symbols of a particular packet. The recovered code symbols are then provided to a Cyclic Redundancy Check (CRC) evaluator 160. The CRC evaluator 160 accumulates a number of code symbols until an entire packet has been received. At the transmitter a CRC is associated with a packet, and as is well known in the art is calculated based upon the contents of the packet. Accordingly, the CRC evaluator 160 determines whether the packet, as recovered by receiver, has been correctly received by performing an evaluation using the recovered CRC. If the CRC evaluator 160 determines that the packet recovered by the receiver is not correct based upon the CRC calculation, then it is determined that there was an error in the decoding of the packet.

The CRC evaluator 160 can provide an indication of the number of packet errors to the CQI determination processing block 120, for use in the CQI determination. Based upon the determination of the CRC evaluator 160, ACK/NAK generator 170 will transmit either a positive acknowledgment (ACK) or a negative acknowledgment (NAK) to the transmitter indicating whether the particular received packet has been correctly decoded. If the particular received packet has not been correctly decoded, and hence, a NAK is transmitted to the transmitter, the transmitter will retransmit the particular packet using a transport format based upon the CQI indicated by CQI determination processing block 120.

FIG. 1B illustrates a radio receiver in accordance with one embodiment of the present invention. In accordance with this embodiment of the present invention, information about the transport format of a received packet and the CQI determination are employed to determine whether to decode a received packet. Accordingly, as illustrated in FIG. 1B, information from HARQ processing block 130 and from CQI determination processing block 120 are provided to an early NAK processor 180. Based upon the received information, the early NAK processor 180 controls whether the received packet is provided to Turbo decoder 140 or whether the received packet is stored in memory 185 until receipt of a retransmitted packet. Although memory 185 is illustrated as only being connected to the HARQ processing block 130, this memory can be part of the HARQ processing block, or can be a common memory employed by other components of the receiver. The result of the soft combination of the received and retransmitted packets is provided to Turbo decoder 140.

The HARQ processing block 130 can provide information about the transport format employed for the received packet. The transport format is relayed over a control channel such as the High Speed Shared Control Channel (HS-SCCH). The CQI determination processing block 120 provides the determined CQI value to early NAK processor 180. Based upon the received information, the early NAK processor 180 controls whether the received packet is provided to Turbo decoder 140. If the early NAK processor 180 determines that the received packet should not be decoded by Turbo decoder 140, the early NAK processor 180 controls ACK/NAK generator 170 such that a NAK is sent to the transmitter, thereby indicating that a retransmission of the received packet is necessary. The transport format of the retransmission can be based on the CQI value which is provided to the transmitter and the early NAK processor 180.

The determination of whether to provide the received packet to Turbo decoder 140 is based upon a correspondence between the transport format employed for the received packet and the channel quality determined by the CQI determination processing block 120. Specifically, if the CQI determination processing block 120 indicates that the channel quality for the time period during which the packet was received is relatively poor, and the transport format employed for the received packet indicates that the transport format was selected for a relatively better channel quality, it is determined that it is unlikely that the received packet can be individually decoded since the transport format employed was not designed to protect the packet against such a relatively poor channel.

The exact correspondence between whether a received packet should be decoded based upon particular CQI value and transport format can be determined by one of ordinary skill in the art through routine experimentation. Specifically, by employing well-known simulation tools, packets with a particular transport format can be transmitted for a variety of channel qualities corresponding to a variety of channel quality indicators. Each of these packets are individually decoded and a CRC evaluation is performed to determine whether the packet was correctly decoded. If the packet was not correctly decoded, then it is determined that packets with that particular transport format should not be individually decoded when the particular channel quality conditions exist. Using the results of the simulation, a table can be built indicating for particular CQI values and transport formats whether a particular received packet should be decoded, or whether the particular received packet should be stored and a NAK sent to the transmitter. The table can be stored in a memory of the receiver when the receiver is manufactured, or at a later time. The CQI values which are compared to the CQI values stored in the table can be modified to account for whether the received packet is a retransmitted packet since the joint decoding of the packets results in a better SIR. As an alternative to, or in addition to, using simulations, the receiver can be programmed to adapt/learn which combination of CQI values and transport formats it can successfully decode. Although FIGS. 1A and 1B illustrate various components being distinct components, these components can be part of the same component, e.g., a processor. These components can be implemented in hardware, software, or a combination of hardware and software.

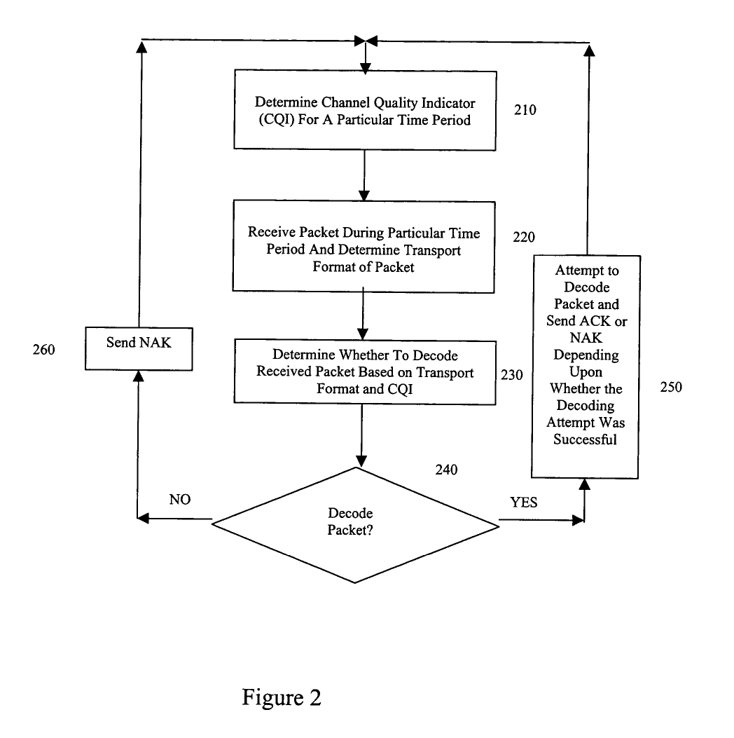

FIG. 2 illustrates an exemplary method for determining whether to decode a packet. Initially, a channel quality indicator (CQI) is determined for a particular time period (step 210). During that particular time period a packet is received and the particular transport format employed for the packet is determined (step 220). Next it is determined whether to decode the received packet based upon the transport format and the CQI (step 230). If it is determined that the packet should be decoded (“YES” path of decision step 240), then an attempt to decode the packet is performed, and a NAK or ACK is transmitted to the transmitter depending upon whether the decoding was successful (step 250). If it is determined that the received packet should not be decoded (“NO” path of decision step 240), then a NAK is sent to the transmitter (step 260). Regardless of whether decoding of the packet has been attempted, the received packet is stored until the packet has been successfully decoded. As indicated by the return paths from steps 250 and 260 to step 210, this process can be repeated for a plurality of time periods and a plurality of received packets. In the case of a NAK, the retransmitted packet may not be the next packet received. However, the retransmitted packet can be received after a number of other packets have been received, and at that point the originally received packet and the retransmitted packet would be jointly decoded by the Turbo decoder. Although the method illustrated in FIG. 2 is described as determining the CQI and then the transport format indicator, these steps can be performed in the opposite order, or they can be performed in parallel.

The invention has been described with reference to a particular embodiment. However, it will be readily apparent to those skilled in the art that it is possible to embody the invention in specific forms other than those of the preferred embodiment described above. This may be done without departing from the spirit of the invention.

Thus, the preferred embodiments are merely illustrative and should not be considered restrictive in any way. The scope of the invention is given by the appended claims, rather than the preceding description, and all variations and equivalents which fall within the range of the claims are intended to be embraced therein.

1. A method of determining whether to decode a packet comprising:
determining a channel quality indication during a period of time;
receiving a packet during the period of time, wherein the received packet has a transport format;
determining whether to the decode the received packet based on the determined channel quality indication and the transport format.

2. The method of claim 1, further comprising:
transmitting a negative acknowledgment when it is determined not to decode the packet.

3. The method of claim 1, further comprising:
determining a second channel quality indication during a second period of time;
receiving a second packet during the second period of time, the second packet has a second transport format;
determining whether to jointly decode the packet and the second packet based on the determined second channel quality indication and the second transport format.

4. The method of claim 3, wherein the determination of whether to jointly decode is also based on whether the second packet is a retransmission of the packet.

5. The method of claim 1, wherein if it is determined to decode the received packet, the method further comprises:
decoding the packet;
performing a packet integrity evaluation on the decoded packet; and
transmitting an acknowledgment if the packet integrity evaluation is successful; and
transmitting a negative acknowledgment if it is determined that the packet integrity evaluation fails.

6. The method of claim 1, wherein the transport format comprises a particular coding format and a particular modulation.

7. The method of claim 1, wherein the determination of whether to decode the received packet comprises:
identifying a field in a table corresponding to the determined channel quality indication and the transport format, wherein the field indicates whether to decode the received packet.

8. An apparatus comprising:
a receiver which receives a packet with a transport format during a period of time; and
a processor which determines a channel quality indication during the period of time, and which determines whether to decode the received packet based on the determined channel quality indication and the transport format.

9. The apparatus of claim 8, further comprising:
a transmitter which transmits a negative acknowledgement when it is determined not to decode the packet.

10. The apparatus of claim 8, wherein the receiver receives a second packet with a second transport format during a second period of time,
wherein the processor determines a second channel quality indication during the second period of time, and which determines whether to jointly decode the packet and the second packet based on the determined second channel quality indication and the second transport format.

11. The apparatus of claim 10, wherein the determination of whether to jointly decode is also based on whether the second packet is a retransmission of the packet.

12. The apparatus of claim 8, wherein the processor comprises a first processor which determines the channel quality indication, and a second processor which determines whether to decode the received packet.

13. The apparatus of claim 8, further comprising:
a decoder which decodes the received packet when it is determined that the received packet should be decoded.

14. The apparatus of claim 13, wherein the decoder is a Turbo decoder.

15. The apparatus of claim 13, wherein the processor comprises the decoder.

16. The apparatus of claim 13, wherein the apparatus is a wireless radio transceiver.

17. The apparatus of claim 13, further comprising:
a packet integrity evaluator which evaluates the integrity of the decoded packet, wherein the transmitter transmits an acknowledgment if the packet integrity evaluation is successful, and the transmitter transmits a negative acknowledgment if it is determined that the packet integrity evaluation fails.

18. The apparatus of claim 8, wherein the transport format comprises a particular coding format and a particular modulation.

19. The apparatus of claim 8 further comprising:
a memory which stores a table, the table including a field in a table corresponding to the determined channel quality indication and the transport format, wherein the field indicates whether to decode the received packet.

20. The apparatus of claim 8, wherein the apparatus operates according to High-Speed Downlink Packet Access (HSDPA).

21. A computer-readable storage medium having stored therein one or more program instructions for causing a processor to determine whether to decode a packet by performing:
determining a channel quality indication during a period of time;
receiving a packet during the period of time, wherein the received packet has a transport format;
determining whether to the decode the received packet based on the determined channel quality indication and the transport format.

22. The computer-readable storage medium of claim 21, wherein a negative acknowledgment is transmitted when it is determined not to decode the packet.

23. The computer-readable storage medium of claim 21, wherein the transport format comprises a particular coding format and a particular modulation.

24. The computer-readable storage medium of claim 21, wherein the determination of whether to decode the received packet comprises:
identifying a field in a table corresponding to the determined channel quality indication and the transport format, wherein the field indicates whether to decode the received packet.
